(19) United States
(12) Patent Application Publication
(10) Pub. No.: US 2015/0271480 A1
(43) Pub. Date: Sep. 24, 2015

(54) DISPLAY APPARATUS AND MULTI-VIEW IMAGE DISPLAY METHOD THEREOF

(71) Applicant: SAMSUNG ELECTRONICS CO., LTD., Suwon-si (KR)

(72) Inventors: In-hak NA, Yongin-si (KR); Dong-choon HWANG, Suwon-si (KR); Do-young KIM, Hwaseong-si (KR); Jin-sung KIM, Seoul (KR); Hyun-jung KIM, Suwon-si (KR); Jun-ho KOH, Suwon-si (KR)

(73) Assignee: SAMSUNG ELECTRONICS CO., LTD., Suwon-si (KR)

(21) Appl. No.: 14/665,313

(22) Filed: Mar. 23, 2015

Related U.S. Application Data
(60) Provisional application No. 61/969,193, filed on Mar. 23, 2014.

(30) Foreign Application Priority Data
Feb. 16, 2015 (KR) 10-2015-0023605

(51) Int. Cl. H04N 13/04; G09G 5/18

(52) U.S. Cl. CPC H04N 13/0404; G09G 5/18

(57) ABSTRACT

A display apparatus is provided. The display apparatus includes an image panel comprising a plurality of pixels and configured to display an image frame in which multi-view images are disposed according to a preset arrangement pattern, a visual field separator disposed on a front surface of the image panel and configured to provide different optical views to respective viewing zones, and a controller configured to control a driving state of the visual field separator to sequentially display first and second image frames each of which comprises different multi-view images during one image frame period and to shift a viewing zone provided for displaying the second image frame by a preset distance based on a viewing zone provided for displaying the first image frame.

### CROSS-REFERENCE TO RELATED APPLICATIONS

This application claims priority from Korean Patent Application No. 10-2015-0023605, filed on Feb. 16, 2015, and U.S. Provisional Application No. 61/969,193, filed on Mar. 23, 2014, the disclosures of which are incorporated herein by reference in their entirety.

### BACKGROUND

1. Field

Apparatuses and methods consistent with exemplary embodiments of the inventive concept relate to a display apparatus and a multi-view image display method thereof, and more particularly, to a display apparatus and a multi-view image display method thereof, for providing a stereoscopic image using a glassless method.

2. Description of the Related Art

Recently, research has been accelerated in a display apparatus providing more realistic display. The display apparatus may be classified into a glass type and a glassless type according to whether to use glasses for viewing a stereoscopic image.

In the case of a glassless method, a multi-view image is displayed and images captured at different views are incident on right and left eyes of a user through a lenticular lens or a parallax barrier, and thus the user experiences a stereoscopic effect.

In addition, for the glassless method, manufacturers have developed display apparatuses for a viewing distance (i.e., a distance between a display apparatus and a user) of about 3 m in consideration of user's fatigue. Hereinafter, the viewing distance will be referred to as a reference viewing distance.

For example, as illustrated in FIG. 1, a distance L2 between an image panel 10 with a pixel size of 0.21 mm and a lenticular lens 20 (or a parallax barrier) is 10 mm and a first view image and a second view image are positioned with an interval of 63 mm at a point corresponding to a viewing distance L1 of 3 m. A position in which an image is formed at the reference viewing distance may be referred to as a viewing zone. Here, users may receive a stereoscopic image at a point spaced apart from a display apparatus by 3 m in that 63 mm is a distance used in consideration of an interval between two eyes of the user.

In general, a material such as glass forms a structure between the image panel 10 and the lenticular lens 20, and it is important to reduce the size of this material in order to reduce the cost and weight of a display apparatus. However, when an interval between the image panel 10 and the lenticular lens 20 is reduced, an interval between the first view image and the second view image may not be maintained at 63 mm with respect to the reference viewing distance, and thus a stereoscopic image may not be provided to the user.

Accordingly, there is a need for a method for reducing a distance between an image panel and a lenticular lens while maintaining an optimum viewing distance.

### SUMMARY

Exemplary embodiments of the inventive concept may overcome the above disadvantages and other disadvantages not described above. Also, the exemplary embodiments, however, are not required to overcome the disadvantages described above, and may not overcome any of the problems described above.

The exemplary embodiments provide a display apparatus and a multi-view image display method thereof, for providing a stereoscopic image using a glassless method while reducing a distance between an image panel and a lens and mainlining an optimum viewing distance to a user.

According to an exemplary embodiment, there is provided a display apparatus which may include: an image panel comprising a plurality of pixels and configured to display an image frame in which multi-view images are disposed according to a preset arrangement pattern; a visual field separator disposed on a front surface of the image panel and configured to provide different optical views to respective viewing zones; and a controller configured to control a driving state of the visual field separator to sequentially display first and second image frames each of which comprises different multi-view images during one image frame period and to shift a viewing zone provided for displaying the second image frame by a preset distance based on a viewing zone provided for displaying the first image frame.

The controller may differently control the driving state of the visual field separator to provide a plurality of viewing zones for displaying the second image frame between a plurality of viewing zones provided during displaying of the first image frame.

The controller may drive the visual field separator to provide a first optical view of the first image frame and a second optical view of the first image frame adjacent to the first optical view to a first viewing zone and a second viewing zone adjacent to the first viewing zone, respectively, and to provide a third optical view of the second image frame to a third viewing zone between the first viewing zone and the second viewing zone.

A distance between the first viewing zone and the third viewing zone may correspond to a distance between right and left eyes of a user, and the third optical view may be a view from a viewpoint adjacent to a viewpoint for the first optical view.

The visual field separator may include a lens module including a plurality of electrodes and a liquid crystal layer configured to form lenses at different positions according to a position of an electrode with a voltage applied thereto among the plurality of electrodes, and the controller may control to apply a voltage to a first electrode among the plurality of electrodes so as to form a lens corresponding to a region in which the first image frame is to be displayed, and to apply a voltage to a second electrode adjacent to the first electrode so as to form a lens at a position shifted by a preset interval for displaying the second image frame.

The visual field separator may include a barrier including a plurality of electrodes and configured to transmit or shield light emitted from the image panel according to whether a voltage is applied to the plurality of electrodes, and the controller may control to apply a voltage to an electrode among the plurality of electrodes corresponding to a number of pixels of the image panel for displaying the first image frame, and to apply a voltage to another electrode among the plurality of electrodes for displaying the second image frame.

A distance between the visual field separator and the image panel may be equal to or less than a preset distance.

The controller may provide the first image frame and the second image frame at 120 Hz.

According to an exemplary embodiment, there is provided a display panel which may include: an image panel including a plurality of pixels and configured to sequentially display a first image frame, including first multi-view images, and a second image frame including second multi-view images different from the first multi-view images, during one image frame period; and a visual field separator disposed on a front surface of the image panel and configured to provide different optical views to respective viewing zones, wherein the visual field separator configured to separate a visual field so as to shift a viewing zone provided for displaying the second image frame based on a viewing zone provided for displaying the first image frame.

The visual field separator may separate the visual field so as to provide a first optical view and a second optical view adjacent to the first optical view to a first viewing zone and a second viewing zone adjacent to the first viewing zone, respectively, during displaying the first image frame, and to provide a third optical view to a third viewing zone between the first viewing zone and the second viewing zone during displaying the second image frame.

According to an exemplary embodiment, there is provided a method of displaying a stereoscopic image of a display apparatus including an image panel including a plurality of pixels and configured to display an image frame in which multi-view images are disposed according to a preset arrangement pattern, and a visual field separator disposed on a front surface of the image panel and configured to provide different optical views to a plurality of viewing zones. The method may include controlling the visual field separator to provide different optical views to respective preset viewing zones during displaying a first image frame, and to provide other different optical views to viewing zones respectively shifted from the preset viewing zones during displaying the second image frame.

The controlling the visual field separator may include differently controlling a driving state of the visual field separator to provide a plurality of viewing zones for displaying the other different optical views between the preset viewing zones for the displaying the first image frame.

The controlling the visual field separator may include driving the visual field separator to provide a first optical view of the first image frame and a second optical view of the first image frame adjacent to the first optical view to a first viewing zone and a second viewing zone adjacent to the first viewing zone, respectively, and to provide a third optical view of the second image frame to a third viewing zone between the first viewing zone and the second viewing zone.

A distance between the first viewing zone and the third viewing zone may correspond to a distance between right and left eyes of a user, and the third optical view may be a view from a viewpoint adjacent to a viewpoint for the first optical view.

The third optical view may be a view from a viewpoint which is closest to a viewpoint for the first optical view among all optical views provided during displaying the second image frame.

The visual field separator may include a lens module including a plurality of electrodes and a liquid crystal layer configured to form lenses at different positions according to a position of an electrode with a voltage applied thereto among the plurality of electrodes, and the controlling the visual field separator may include controlling to apply a voltage to a first electrode among the plurality of electrodes so as to form a lens corresponding to a region in which the first image frame is to be displayed, and to apply a voltage to a second electrode adjacent to the first electrode so as to form a lens at a position shifted by a preset interval for displaying the second image frame.

The visual field separator may include a barrier unit including a plurality of electrodes and configured to transmit or shield light emitted from the image panel according to whether a voltage is applied to the plurality of electrodes, and the controlling the visual field separator may include controlling to apply a voltage to an electrode among the plurality of electrodes corresponding to a number of pixels of the image panel for displaying the first image frame, and to apply a voltage to another electrode among the plurality of electrodes for displaying the second image frame.

A distance between the visual field separator and the image panel may be equal to or less than a preset distance.

The first image frame and the second image frame may be provided at 120 Hz.

According to the various exemplary embodiments, the cost and weight of a display apparatus may be reduced in that a distance between an image panel and a lens is reduced while providing an optimum stereoscopic image to a user.

Additional and/or other aspects and advantages of the inventive concept will be set forth in part in the description which follows and, in part, will be obvious from the description, or may be learned by practice of the invention.

### BRIEF DESCRIPTION OF THE DRAWING FIGURES

The above and/or other aspects of the inventive concept will be more apparent by describing certain exemplary embodiments with reference to the accompanying drawings, in which:

FIG. 1 is a diagram for explanation of an operation of a display apparatus for providing a stereoscopic image using a general glassless method;

FIG. 2 is a block diagram illustrating a structure of a display apparatus according to an exemplary embodiment;

FIGS. 3A and 3B are diagrams for explanation of a method for forming a visual field to help the understanding;

FIGS. 4A to 4C are diagrams for explanation of a method for driving an image display according to various exemplary embodiments;

FIGS. 5A to 5C are diagrams illustrating a method for forming a lens when a visual field separator is embodied as a liquid crystal type lenticular lens according to an exemplary embodiment;

FIGS. 6A to 6D are diagrams for explanation of a lens shifting method in detail when a visual field separator is embodied as a liquid crystal type lenticular lens according to an exemplary embodiment; and

FIG. 7 is a flowchart for explanation of a method of displaying a multi-view image of a display apparatus according to an exemplary embodiment.

### DETAILED DESCRIPTION OF THE EXEMPLARY EMBODIMENTS

Various example embodiments will be described more fully with reference to the accompanying drawings, in which some example embodiments are shown. The inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. Like reference numerals refer to like elements throughout this application.

It will be understood that, although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present inventive concept. As used herein, the term “and/or” includes any and all combinations of one or more of the associated listed items.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The exemplary embodiments of the inventive concept will now be described in greater detail with reference to the accompanying drawings.

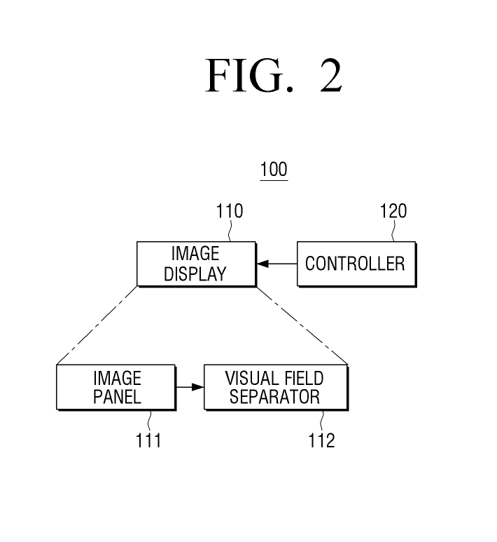

FIG. 2 is a block diagram illustrating a structure of a display apparatus 100 according to an exemplary embodiment.

The display apparatus 100 of FIG. 2 may be embodied as various types of display apparatuses such as a television (TV), a monitor, a cellular phone, a personal digital assistance (PDA), a personal computer (PC), a set-top PC, a tablet PC, an electronic frame, a kiosk, and so on.

Referring to FIG. 2, the display apparatus 100 includes an image display 110 and a controller 120, and the image display 110 includes an image panel 111 and a visual field separator 112.

The image panel 111 includes a plurality of pixels, each of which includes a plurality of sub-pixels. Here, a sub-pixel may include red (R), green (G), and blue (B) sub-pixels. That is, pixels including R, G, and B sub-pixels may be arranged in a plurality of row and column directions to constitute the image panel 111.

In addition, the image panel 111 displays an image frame. In detail, the image panel 111 displays the image frame on which multi-view images are arranged according to a preset arrangement pattern.

Although not illustrated in FIG. 2, when the image panel 111 is embodied as a liquid crystal display (LCD) panel, the display apparatus 100 may further include a backlight module (not shown) for providing backlight to the image panel 111 and a panel driver (not shown) for driving pixels of the image panel 111 according to pixel values of pixels of the image frame.

Accordingly, in response to light generated from the backlight module (not shown) being incident on each pixel of the image panel 111, the image panel 111 adjusts transmittance of light incident on each pixel according to an image signal and displays the image frame. In detail, the image panel 111 includes a liquid crystal layer and two electrodes formed on opposite surfaces of the liquid crystal layer. In response to a voltage being applied to the two electrodes, an electric field is generated to move molecules of the liquid crystal layer between the two electrodes so as to adjust transmittance of light.

Alternatively, the image panel 111 may be embodied as an organic light emitting diode (OLED) panel including a self-emission element. In detail, the image panel 111 may include a plurality of pixels arranged thereon, and each pixel may include a self-emission element for emitting light to correspond to current flow, an ELVDD for supplying current to the self-emission element, a driving transistor for controlling the current supplied to the self-emission element, and so on. Here, the self-emission element may be an organic light emitting diode. A plurality of pixels may each include RGB pixels that may simultaneously or sequentially emit light.

The visual field separator 112 is disposed on a front surface of the image panel 111. In this case, the visual field separator 112 may be embodied as a liquid crystal type lenticular lens using a liquid crystal lens panel, a lens type lenticular lens, or a parallax barrier.

For example, the visual field separator 112 may embodied as a liquid crystal type lenticular lens using a liquid crystal lens panel including a plurality of lens regions, or a lenticular lens. Thus, the lenticular lens may refract an image displayed on the image panel 111 through the plurality of lens regions. Each lens region may be formed with a size corresponding to at least one pixel so as to differently disperse light transmitted through each pixel for respective viewing zones.

As another example, the visual field separator 112 may be embodied as a parallax barrier. The parallax barrier may be embodied as a transparent slit array including a plurality of barrier regions. Thus, light may be shielded through a slit between the barrier regions so as to output images with different views for the respective viewing zones.

The visual field separator 112 may be operated while being inclined at a predetermined angle with respect to a sub-pixel of the image panel 111 for image enhancement. A controller 130 may divide an image frame of each image captured at a plurality of views into a plurality of portions based on the angle at which the visual field separator 112 is inclined and combines the divided portions to generate an image frame to be viewed by a user. Accordingly, a user may view an image displayed with predetermined inclination with respect to a sub-pixel of the image panel 111 rather than viewing an image displayed in a perpendicular or horizontal direction with respect to the sub-pixel of the image panel 111.

The controller 130 controls an overall operation of the display apparatus 100.

In particular, the controller 130 may sequentially display first and second image frames each of which is formed of different multi-view images and may differently control a driving state of the visual field separator 112 so as to shift a viewing zone provided for displaying the second image frame based on a viewing zone provided for displaying the first image frame. In this case, the controller 130 may drive the image display 110 at high speed to provide the first and second image frames, and for example, may drive the image display 110 at 120 Hz to display the first image frame and the second image frame.

In detail, the controller 130 may differently control a driving state of the visual field separator 112 for shifting a liquid crystal lens and separating a visual field so as to shift and provide a viewing zone provided for display the second image frame based on a viewing zone provided for displaying the first image frame.

In more detail, the controller 130 may drive the visual field separator 112 during one image frame period to provide a first optical view of a first image frame and a second optical view, adjacent to the first optical view, of the first image frame to a first viewing zone and a second viewing zone adjacent to the first viewing zone, respectively, and to provide a third optical view of a second image frame to a third viewing zone between the first viewing zone and the second viewing zone. In this case, a distance between the first viewing zone and the third viewing zone may correspond to a distance (e.g., 65 mm) between right and left eyes of a user, and the third optical view may be a view from a view point adjacent to a view point for the first optical view.

For example, the controller 130 renders a plurality of multi-view images based on an input image and depth information, and displays an image frame on which the rendered multi-view images are disposed according to a preset arrangement pattern through the image panel 111. For example, when the controller 130 renders 36 multi-view images, the controller 130 may generate and provide an image frame based on four (4) multi-view images so as to provide a total of nine (9) optical views. That is, the number of rendered multi-view images may not be equal to the number of provided optical views, and may be changed according to a setting state. When the controller 130 displays 36 multi-view images to provide different 1^{st} to 9^{th} optical views to nine (9) different viewing zones during displaying the first image frame, the controller 130 may provide 10^{th} to 18^{th} optical views different from the 1^{st} to 9^{th} optical views between the nine (9) viewing zones to which the 1^{st} to 9^{th} optical views are provided, during displaying the second image frame. In this case, the 10^{th} to 18^{th} optical views may be generated based on a multi-view image which is different from a multi-view image that generates the 1^{st} to 9^{th} optical views. However, even if the 10^{th} optical view formed between the 1^{st} and 2^{nd} optical views is generated based on a different multi-view image, the 10^{th} optical view may be formed based on a multi-view image which does not have a large depth difference from the multi-view image of the 1^{st} and 2^{nd} optical views. Accordingly, even if the 1^{st} optical view provided during displaying the first image frame and the 10^{th} optical view provided during displaying the second image frame are provided to right and left eyes of a user, respectively, a smooth three-dimensional (3D) image can be provided.

The visual field separator 112 may include a lens module which includes a plurality of electrodes and a liquid crystal layer in which liquid crystal-types of lenticular lenses are formed at different positions according to a position of an electrode to which a voltage is applied among the plurality of electrodes. The visual field separator may also include a voltage driver for applying the voltage to the lens module. The controller 130 may control the voltage driver to apply a voltage to an electrode among the plurality of electrodes so as to form a lens at a preset position for displaying the first image frame, and to apply a voltage to another electrode adjacent to the electrode so as to form a lens at a position shifted by a preset interval from the previously formed lens for displaying the second image frame.

In addition, the visual field separator 112 may include a barrier and a plurality of electrodes (not shown). The barrier is provided for transmitting or shielding light emitted from the image panel 111 according to whether a voltage is applied to the plurality of electrodes. The visual field separator 112 may also include a voltage driver for applying a voltage to the barrier. These electrodes and this voltage driver may be the same electrodes and voltage driver for applying a voltage to the lens module described above. The controller 130 may control the voltage driver to apply a voltage to an electrode corresponding to the number of pixels of an image panel so as to provide the first optical view to the first viewing zone during displaying the first image frame, and to apply a voltage to an adjacent electrode so as to provide the second optical view to the second viewing zone during displaying the second image frame.

In addition, a glass module (not shown) may be disposed between the visual field separator 112 and the image panel 111, and a distance between the visual field separator 112 and the image panel 111 that are formed by the glass module may be equal to or less than a preset distance (e.g., 5 mm).

Although FIG. 2 illustrates only the image display 110 and the controller 120, the display apparatus 100 may further include other components for performing a 3D display function. For example, the display apparatus 100 may further include an image receiver for receiving an image and depth information of the image from various external devices such as an external storage medium, a broadcaster, a web server, etc. and a rendering module (not shown) for rendering a multi-view image based on the received image and depth information of the image. For example, in response to a two-dimensional (2D) image being input to the rendering module, the rendering module may render a multi-view image based on depth information extracted via 2D/3D conversion. In addition, in response to multi views, that is, N views and corresponding N pieces of depth information being input to the rendering module, the rendering module may render a multi-view image based on at least one view and depth information among the N input views and depth information. In addition, in response to only N views being input to the rendering module, the rendering module may extract depth information from the N views and then may render a multi-view image based on the extracted depth information.

Hereinafter, various exemplary embodiments will be described in detail with reference to the accompanying drawings

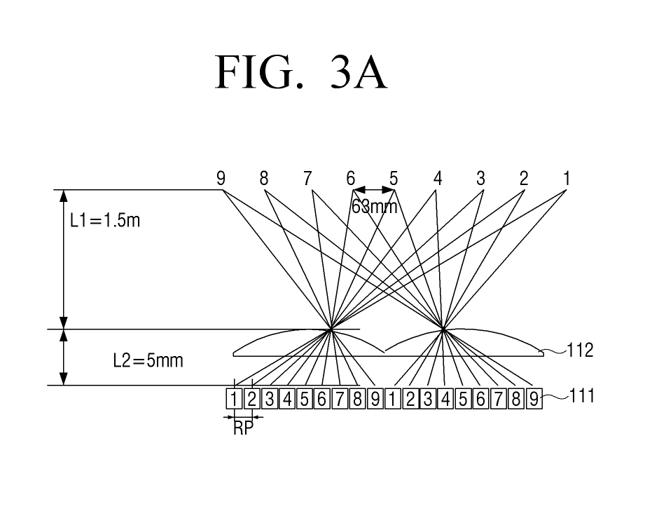

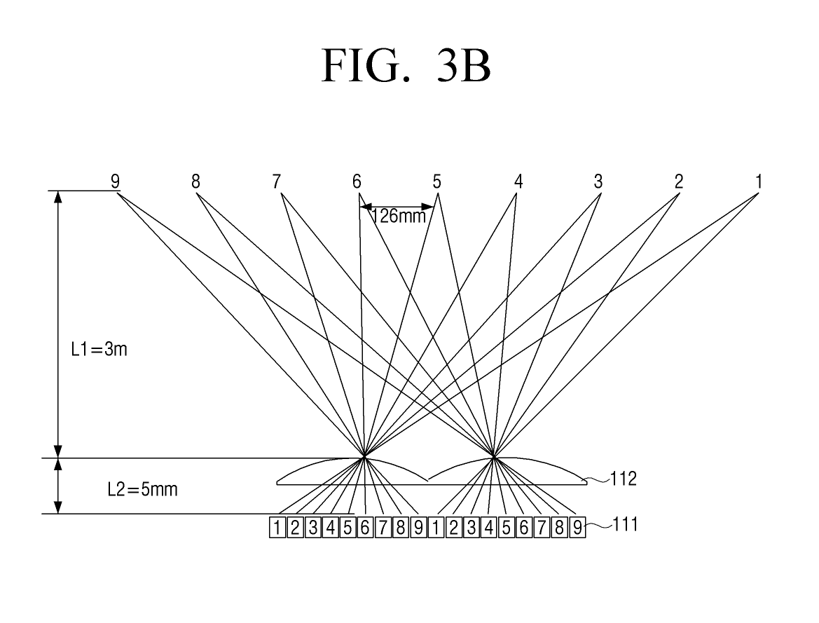

FIGS. 3A and 3B are diagrams for explanation of a method for forming a visual field to help the understanding of the inventive concept.

A multi-view system formed by manufacturing the image panel 111 (i.e., a 2D panel) for displaying an image and the visual field separator 112 (i.e., a 3D filter) for separating a visual field with the same size as the number of sub-pixels of the image panel 111, corresponding to the number of required visual fields is used at an upper portion of the image panel 111 so as to form visual fields. In detail, in the multi-view system, a relation of “binocular disparity: pixel pitch=viewing distance: spacer (distance between 2D panel and 3D filter)” is satisfied, and thus assuming that a human binocular disparity is 63 mm, a preset distance between the 2D panel and the 3D filter is required in order to form a visual field at a viewing distance of 3 m, and a flat medium such as a glass and so on is used in order to maintain the distance.

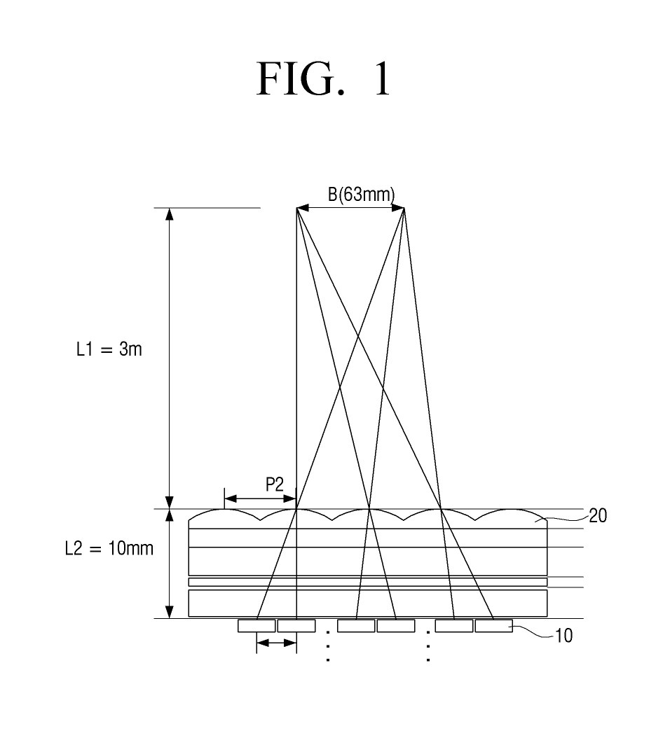

For example, as shown in FIG. 1, when the distance L2 between the image panel 111 and the visual field separator 112 is 10 mm, the viewing distance L1 is formed as 3 m, but as shown in FIG. 3A, when the distance L2 is reduced to 5 mm, the viewing distance L1 is reduced to 1.5 m. In addition, as shown in FIG. 3B, when the viewing distance L1 is maintained as 3 m while reducing the distance L2 is reduced to 5 mm, the binocular disparity is increased to 126 mm. Accordingly, the inventive concept proposes a method for reducing the distance L2 to 5 mm and maintaining the binocular disparity to 63 mm while maintaining the viewing distance L1 to 3 m.

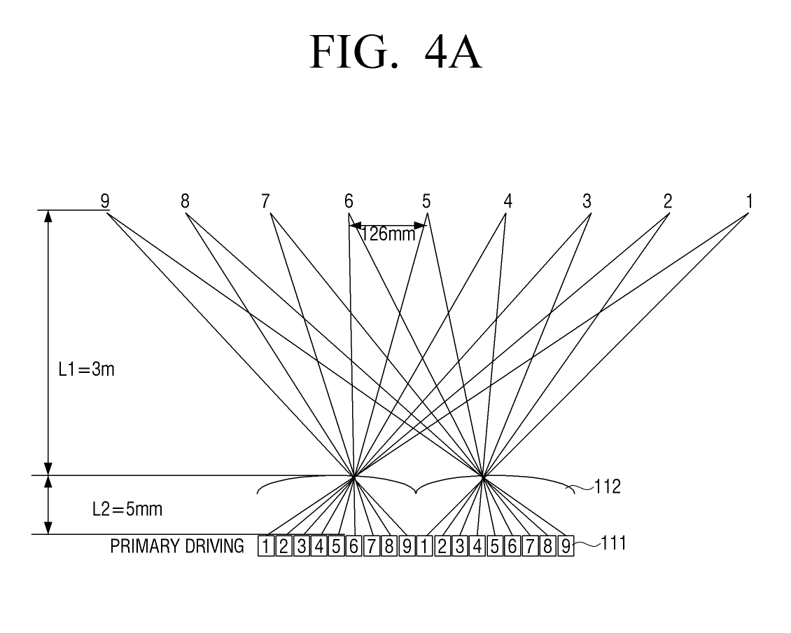

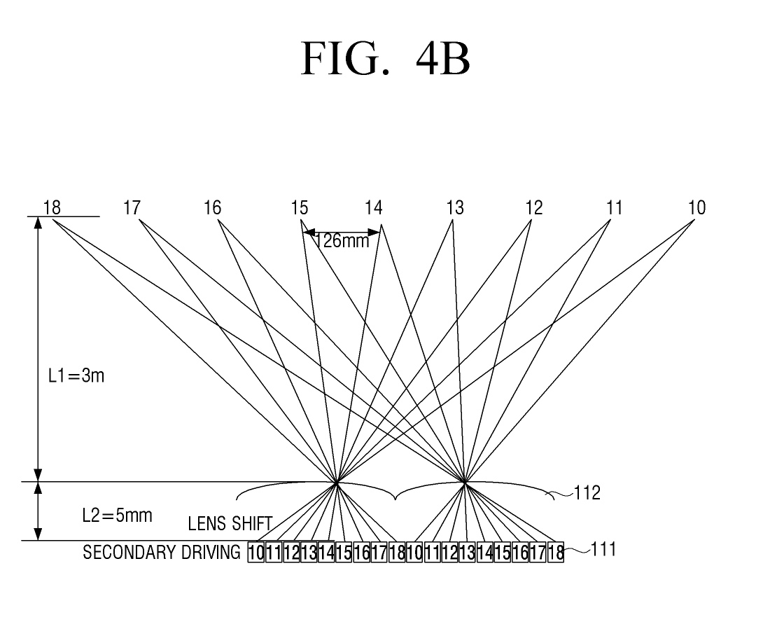

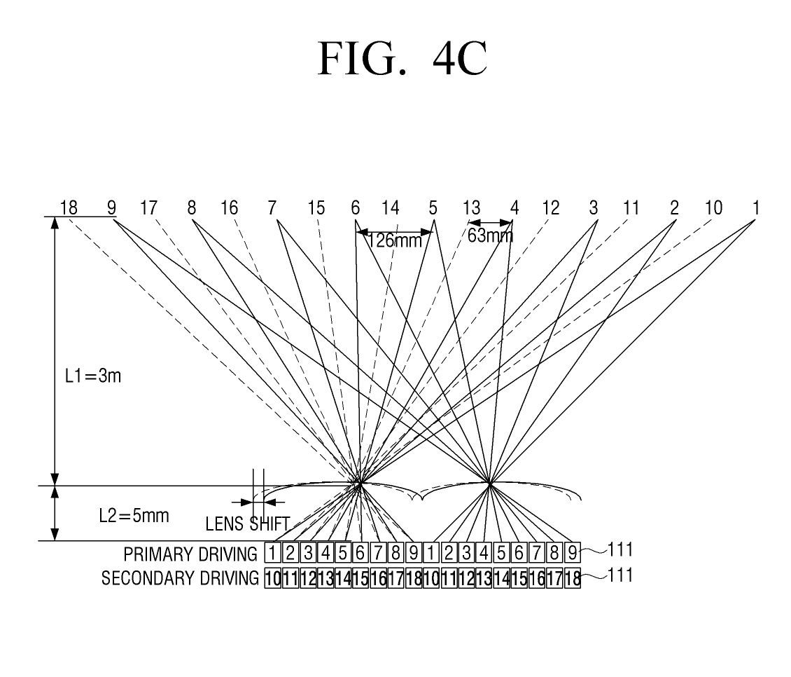

FIGS. 4A to 4C are diagrams for explanation of a method for driving an image display according to various exemplary embodiments.

FIG. 4A is a diagram illustrating a lens driving method in a first image frame. When the distance L2 is reduced to 5 mm and the viewing distance L1 is maintained as 3 m, viewing zones by the first image frame are formed with an interval of 126 mm.

FIG. 4B is a diagram illustrating a lens driving method in a second image frame. When the distance L2 is reduced to 5 mm and the viewing distance L1 is maintained as 3 m, viewing zones by the second image frame are formed with an interval of 126 mm.

FIG. 4C is a diagram illustrating visual fields formed according to sequential driving of FIGS. 4A and 4B. As illustrated in the drawings, in response to a lens formation position being shifted via high speed driving, the distance L2 may be reduced to 5 mm and the binocular disparity may be maintained as 63 mm while maintaining the viewing distance L1 as 3 m. That is, a user may view optical views provided from a viewing zone provided from the first image frame and a viewing zone provided from the second image frame via his or her right and left eyes, and thus the binocular disparity may be maintained as 63 mm.

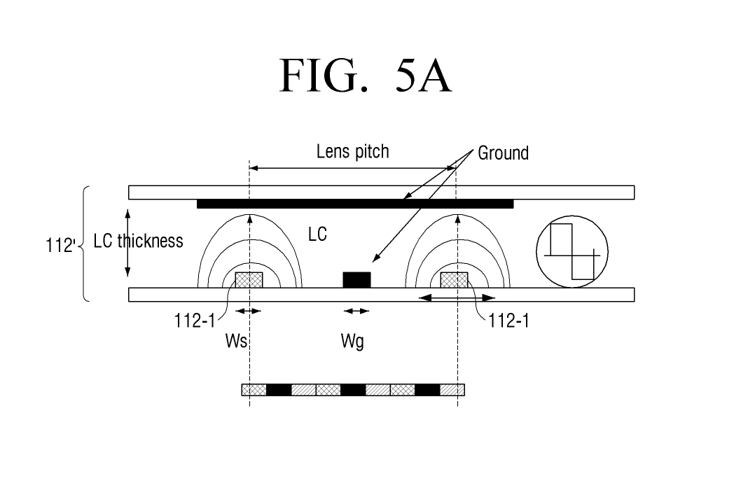

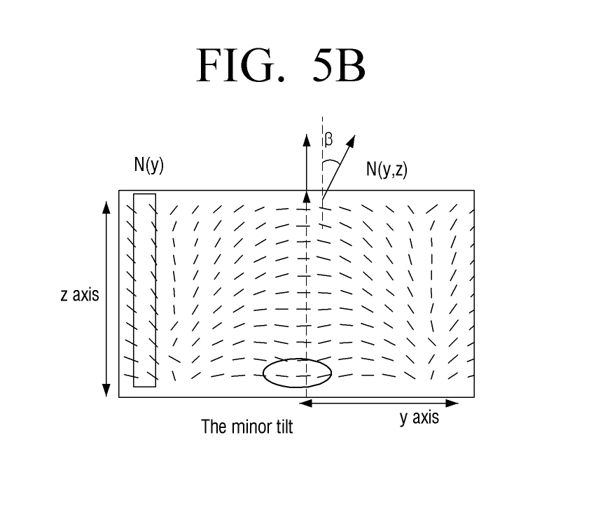

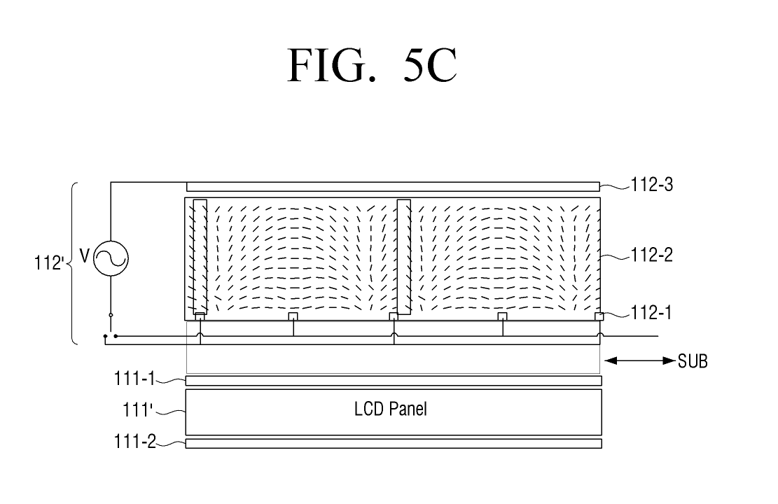

FIGS. 5A to 5C are diagrams illustrating a method for forming a lens when a visual field separator is embodied as a liquid crystal type lenticular lens according to an exemplary embodiment.

FIG. 5A is a diagram illustrating configuration of a lens module 112′ and FIG. 5B is a diagram illustrating a lens shape formed by a liquid crystal lens.

As shown in FIG. 5A, the lens module 112′ may be configured with a lens shape illustrated in FIG. 5B according to whether a voltage is applied to a plurality of electrodes 112-1.

FIG. 5C illustrates an example of an image display to which the lens module 112′ of FIGS. 5A and 5B is applied according to an exemplary embodiment. As illustrated in the drawings, the image panel 111 is embodied as an LCD panel.

As illustrated in the drawings, the image panel 111 may include a front polarizer 111-1, an LCD panel 111′, and a rear polarizer 111-2. However, as necessary, the image panel 111 may include only the rear polarizer 111-2.

One of the front polarizer 111-1 and the rear polarizer 111-2 may be embodied as a vertical polaroid film and the other polarizer may be embodied as a horizontal polaroid film. The rear polarizer 111-2 transmits only light of a specific polarization direction among white light beams provided from a backlight module. The transmitted light may be changed in a polarization direction or may be transmitted without changes according to a liquid crystal arrangement state while passing through the LCD panel 111′. The front polarizer 111-1 transmits light of a perpendicular polarization direction to the rear polarizer 111-2. Thus, light that is changed in a polarization direction while passing through the LCD panel 111′ passes through the front polarizer 111-1 and is transmitted to a polarization panel (not shown), and light that is transmitted through the LCD panel 111′ without changes is shielded by a front polarizer. The image panel 111 drives pixels in each pixel line of the LCD panel 111′ according to a pixel value of each pixel included in an image frame to be displayed.

As illustrated in the diagrams, the lens module 112′ may be disposed at a position spaced apart from the LCD panel 111′ across a sub-frame, a glass, and so on, and the lens module 112′ may be configured to include a plurality of electrodes 112-1, a liquid crystal lens 112-2, and a common electrode 112-3. Hereinafter, a method for forming a lens according to whether a voltage is applied to a plurality of electrodes will be described with reference to the drawings.

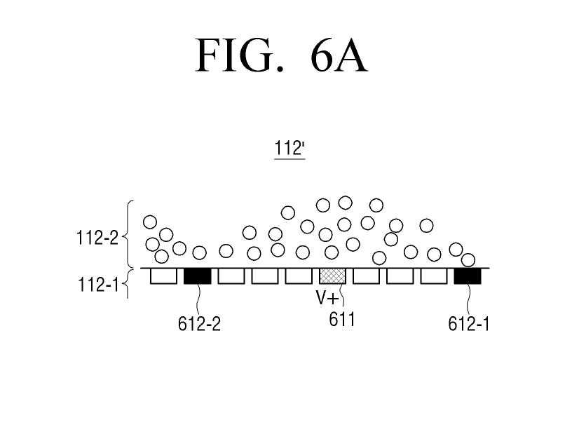

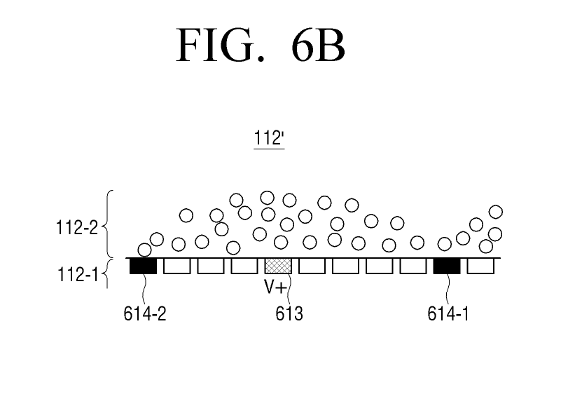

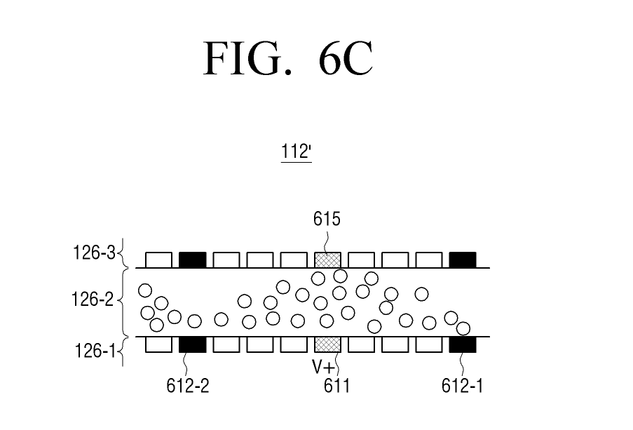

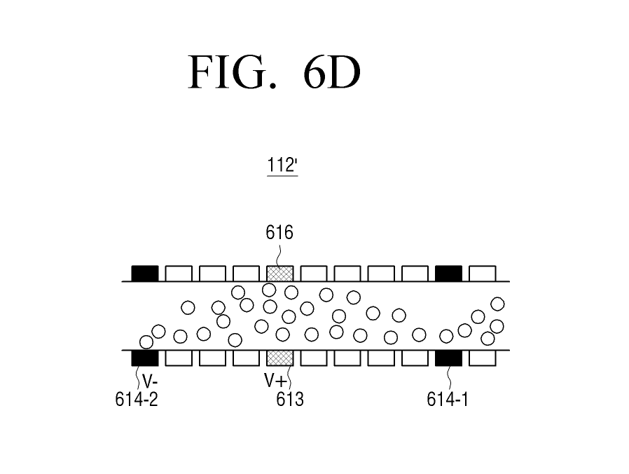

FIGS. 6A to 6D are diagrams for explanation of a lens shifting method in detail when a visual field separator is embodied as a liquid crystal type lenticular lens according to an exemplary embodiment.

The lens module 112′ may control refraction of light emitted from the image panel 111 to provide lenses to different positions in a first viewpoint region and a second viewpoint region of one image frame. In detail, the lens module 112′ may be changed in optical characteristic according to a position of an electrode to which a voltage is applied, among a plurality of electrodes, and may control refraction of light passing through the lens module 112′ to different directions. To this end, the lens module 112′ may include an electrode layer 112-1 and a liquid crystal layer 112-2.

FIGS. 6A and 6B are diagrams illustrating shapes of liquid crystal type lenticular lenses formed during displaying of a first image frame and a second image frame, respectively.

As illustrated in FIG. 6A, the electrode layer 112-1 applies an electric field to the liquid crystal layer 112-2. In this case, the electrode layer 112-1 may be formed of a transparent material with a flat shape in order to minimize influence on light passing through the electrode layer 112-1.

The liquid crystal layer 112-2 may form a lens shape according to a position of an electrode to which a voltage is applied, among a plurality of electrodes included in the electrode layer 112-1. To this end, the liquid crystal layer 112-2 may be formed of a liquid or nano material that is changed in a lens shape according to a voltage.

In detail, in response to a negative (−) voltage being applied to electrodes 612-1 and 612-2 disposed at opposite ends of electrodes corresponding to the same area as the number of pixels in which images of different viewpoints are arranged and a positive (+) voltage is applied to an electrode positioned between the electrodes 612-1 and 612-2 in the image panel 111 during displaying the first image frame, the liquid crystal layer 112-2 may form a liquid crystal (LC) lens at a corresponding position, as shown in the drawings.

Then, as shown in FIG. 6B, in response to a positive (+) voltage and a negative (−) voltage being applied to electrodes 613, 614-1, and 614-2 spaced apart from each other by a preset interval in the same direction as that of the voltage that is applied during displaying the first image frame, during displaying of the second image frame, the liquid crystal layer 112-2 may an LC lens at a shifted position, as shown in the drawings.

In addition, although not illustrated, the lens module 112′ may further include a common electrode layer 112-3 including one electrode. In addition, the lens module 112′ may further include a first substrate (not shown) for supporting the electrode layer 112-1 and the liquid crystal layer 112-2, a medium layer (not shown) formed on the liquid crystal layer 112-2, a second substrate (not shown) formed on the medium layer (not shown), and so on.

In this case, the first substrate may be positioned below the lens module 112′ and may support the lens module 112′, and the second substrate may compensate for refraction when light incident on the lens module 112′ is refracted by the first substrate.

FIGS. 6C and 6D are diagrams for explanation of a configuration and operation of a lens module according to a different exemplary embodiment from the embodiment illustrated in FIGS. 6A and 6B.

As shown in FIGS. 6C and 6D, the lens module 112′ may further include the common electrode layer 112-3 in addition to the components illustrated in FIGS. 6A and 6B.

Referring to FIG. 6C, an LC lens may be formed at a corresponding position using a method for applying a voltage to a common electrode 615 corresponding to a convex region of a shape of a lens formed in a first sub field period as shown in FIG. 6A.

In addition, referring to FIG. 6D, an LC lens may be formed at a shifted position using a method for applying a voltage to a common electrode 616 corresponding to a convex region of a shape of a lens formed in a second sub field period as shown in FIG. 6B.

A liquid crystal type lenticular lens layer may include a liquid crystal region formed by liquid crystal molecules. Liquid molecules in the liquid crystal region may exhibit dielectric anisotropy (Δ∈≠0). Throughout this specification, the term ‘dielectric anisotropy’ may refer to characteristic whereby dielectric constants of a major axis of liquid crystal molecules and a perpendicular direction to the major axis are different. In addition, for definition of angles throughout this specification, the term ‘vertical’, ‘parallel’, ‘perpendicular’, or ‘horizontal’ refers to substantial vertical, substantial parallel, substantial perpendicular, or substantial horizontal as long as the meaning does not damage desired effect thereof, and for example, includes errors in consideration of manufacturing error or variation. For example, the term may include error within about ±15 degrees, error within about ±10 degrees, or error within about ±5 degrees.

When liquid crystal molecules have dielectric anisotropy, orientation of the liquid crystal molecules may be changed according to a voltage applied to a lens layer and intensity thereof. The dielectric anisotropy of liquid crystal molecules may have a positive value or a negative value. The positive value of dielectric anisotropy of liquid crystal molecules indicates that a dielectric constant of a major axis direction of liquid crystal molecules is higher than a dielectric constant of a minor axis direction. In addition, the negative value of dielectric anisotropy of liquid crystal molecules indicates that a dielectric constant of a major axis direction of liquid crystal molecules is lower than a dielectric constant of a minor axis direction. According to an exemplary embodiment, when liquid crystal molecules have positive dielectric anisotropy, if a voltage is applied to a lens layer, the liquid crystal molecules may be re-arranged according to a direction in which the voltage is applied.

According to an exemplary embodiment, a liquid crystal region may be switched to a cholesteric orientation region and a non-cholesteric orientation region.

The liquid crystal layer 112-2 of the cholesteric orientation region may include cholesteric-oriented liquid crystal molecules, as shown in FIG. 5B. The cholesteric-oriented liquid crystal molecules has a helical structure in which liquid crystal molecules constitute a layer and are oriented while a director of the liquid crystal molecules is twisted along a helical axis H. In the helical structure, a distance up to complete rotation of 360 degrees of a director of liquid crystal molecules is referred to as a pitch P.

An appropriate voltage may be applied to a lens layer including the cholesteric orientation region or an applied voltage may be removed at one time point so as to release a cholesteric orientation state while aligning liquid crystal molecules in one direction. In addition, the cholesteric orientation state may be completely released to align all liquid crystal molecules of a liquid crystal region in the same direction. A region including liquid crystal molecules in this state may be referred to as a non-cholesteric orientation region. Here, the cholesteric orientation region and the non-cholesteric orientation region may be switched to each other according to voltage application. For example, a corresponding region may be switched so as to form the cholesteric orientation region or the non-cholesteric orientation region across an entire region. Thus, in response to a voltage being applied to the corresponding region, the same voltage may be applied to an entire region or a region, orientation of which is to be re-arranged. According to an exemplary embodiment, a lens layer to which a voltage is not applied may include a cholesteric orientation region. In response to a voltage for completely releasing a cholesteric orientation state being applied to the lens layer, the cholesteric orientation region may be switched to the non-cholesteric orientation region. In addition, in response to a voltage applied to a lens layer including a non-cholesteric orientation region being removed, the corresponding region may be switched to the cholesteric orientation region.

The cholesteric orientation region may be a planar orientation region, a homeotropic orientation region, or a focal conic orientation region. The planar orientation region may be a region in which liquid crystal molecules are oriented such that a helical axis of the region is perpendicular to a surface of the lens layer. The homeotropic orientation region may be a region in which liquid crystal molecules are oriented such that a helical axis of a corresponding region is parallel to a surface of the lens layer. In addition, the focal conic orientation region may be a region in which liquid crystal molecules are oriented such that a helical axis of a corresponding region is not perpendicular to a surface of a lens layer and is not horizontal to the surface of the lens surface.

However, although not shown, the visual field separator 112 may be embodied as a parallax barrier. In this case, the parallax barrier may include a plurality of electrodes and may transmit or shield light emitted from the image panel 111 according to whether a voltage is applied to the plurality of electrodes.

To this end, the parallax barrier may be embodied to include a common electrode, a polarizer, and a barrier electrode, may transmit light of one direction of a multi-view image, and may shield light of the other direction. In detail, the parallax barrier may adjust positions of a plurality of barrier regions according to whether a voltage is applied to the plurality of electrodes and shield light through a slit between barrier regions so as to emit images of different viewpoints for respective viewing zones.

That is, according to an exemplary embodiment, in a first image frame period and a second image frame period, for displaying one image frame, an image may be formed by shifting a plurality of barrier regions, and thus a viewing zone may be formed at a shifted position from a viewing zone formed in the first image frame period, in the second image frame period. This operation of the parallax barrier may be performed in units of pixels constituting an image or performed in units of sub-pixels constituting one pixel.

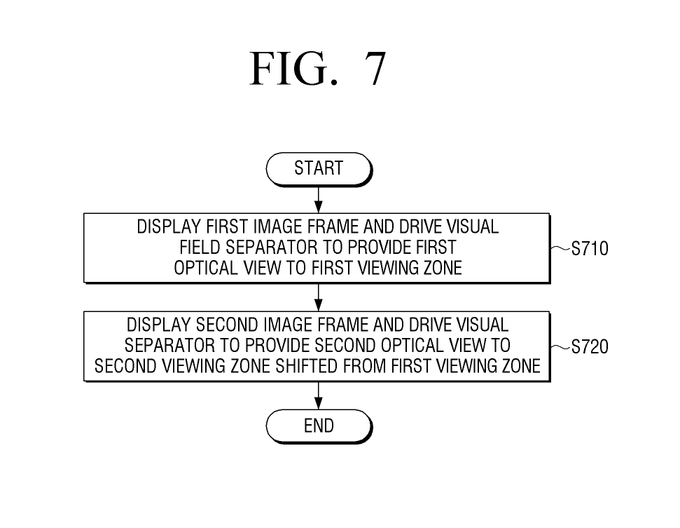

FIG. 7 is a flowchart for explanation of a method of displaying a multi-view image of a display apparatus according to an exemplary embodiment.

With regard to the method of displaying a multi-view image of the display apparatus shown in FIG. 7, the display apparatus may include a plurality of pixels and may also include an image panel for displaying an image frame in which multi-view images are disposed according to a preset arrangement pattern and a visual field separator disposed on a front surface of the image panel and for providing different optical views for respective viewing zones.

According to the method of displaying a multi-view image of the display apparatus shown in FIG. 7, first, the visual field separator is driven to provide different optical views for respective set viewing zones during displaying of the first image frame (S710).

Then the visual field separator is driven to provide different optical views in a viewing zone shifted from a preset viewing zone during displaying of the second image frame (S720).

In detail, in operation S710 for driving the visual field separator, the visual field separator may be differently driven to provide a plurality of viewing zones provided during displaying the second image frame between a plurality of viewing zones provided during displaying the first image frame.

In addition, in operation S710 for driving the visual field separator, the visual field separator may be driven in such a way that, in one image frame period, a first optical view provided during displaying the first image frame and a second optical view adjacent to the first optical view may be provided to the first viewing zone and the second viewing zone adjacent to the first viewing zone, respectively, and a third optical view provided during displaying the second image frame may be provided to a third viewing zone between the first viewing zone and the second viewing zone. Here, a distance between the first viewing zone and the third viewing zone may correspond to a distance between right and left eyes of the user and the third optical view may be provided at a viewpoint adjacent to the first optical view.

Here, the visual field separator may include a plurality of electrodes, a lens module including a liquid crystal layer in which lenses are formed at different positions according to a position of an electrode to which a voltage is applied, among the plurality of electrodes, and a voltage driver for applying a voltage to the lens module. In this case, in operation S710 for driving the visual field separator, the voltage driver may be controlled to apply an electrode to an electrode among the plurality of electrodes so as to form a lens corresponding to a region in which the first image frame is to be displayed and to apply a voltage to an adjacent electrode so as to form a lens at a position shifted by a preset interval during displaying of the second image frame.

In addition, the visual field separator may also include a barrier for transmitting or shielding light emitted from an image panel according to whether a voltage is applied to a plurality of electrodes, and a voltage driver for applying a voltage to the barrier. In this case, in the operation S710 for driving the visual field separator, the voltage driver may be driven to apply a voltage to an electrode among the plurality of electrodes corresponding to the number of pixels of the image panel so as to provide a first optical view to a first viewing zone and to apply a voltage to an adjacent electrode so as to provide a second optical view to a second viewing zone.

As described above, according to the various exemplary embodiments, the cost and weight of a display apparatus may be reduced in that a distance between a 2D panel and a 3D panel is reduced while providing an optimum stereoscopic image to a user.

The aforementioned multi-view image display method of a display apparatus according to various exemplary embodiments may be embodied as a program and provided to the display apparatus.

For example, a non-transitory computer readable medium with a program stored therein for performing the corresponding multi-view image display method may be provided.

Here, the non-transitory computer readable media refers to a medium that semipermanently stores data and is readable by a device instead of a medium that stores data for a short time period, such as a register, a cache, a memory, etc. In detail, the aforementioned programs may be stored and provided in the non-transitory computer readable media such as compact disc (CD), digital versatile disc (DVD), hard disc, Blu-ray disc, universal serial memory (USB), a memory card, read-only memory (ROM), etc.

At least one of the components, elements or units represented by a block as illustrated in FIG. 2 may be embodied as various numbers of hardware, software and/or firmware structures that execute respective functions described above, according to an exemplary embodiment. For example, at least one of these components, elements or units may use a direct circuit structure, such as a memory, processing, logic, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions. Also, at least one of these components, elements or units may further include a processor such as a central processing unit (CPU) that performs the respective functions, a microprocessor, or the like. Two or more of these components, elements or units may be combined into one single component, element or unit which performs all operations or functions of the combined two or more components, elements of units. Further, although a bus is not illustrated in the above block diagrams, communication between the components, elements or units may be performed through the bus. Functional aspects of the above exemplary embodiments may be implemented in algorithms that execute on one or more processors. Furthermore, the components, elements or units represented by a block or processing steps may employ any number of related art techniques for electronics configuration, signal processing and/or control, data processing and the like.

The foregoing exemplary embodiments and advantages are merely exemplary and are not to be construed as limiting the inventive concept. For simplicity of the specification, electronic components, control systems, software, and other functional factors in the related art may be omitted. In addition, connection of lines or connection members between the components in the drawings illustrate functional connection and/or physical or circuital connection as example, and thus in a real apparatus, replaceable or additional diverse functional connection, physical connection or circuital connection may be provided.

While the above exemplary embodiments have been described with reference to the drawings, it will be understood by those of ordinary skill in the art that various changes in form and details may be made therein without departing from the spirit and scope of the inventive concept as defined by the following claims.

What is claimed is:

1. A display apparatus comprising:
an image panel comprising a plurality of pixels and configured to display an image frame in which multi-view images are disposed according to a preset arrangement pattern;
a visual field separator disposed on a front surface of the image panel and configured to provide different optical views to respective viewing zones; and
a controller configured to control a driving state of the visual field separator to sequentially display first and second image frames each of which comprises different multi-view images during one image frame period and to shift a viewing zone provided for displaying the second image frame by a preset distance based on a viewing zone provided for displaying the first image frame.

2. The display apparatus of claim 1, wherein the controller is configured to differently control the driving state of the visual field separator to provide a plurality of viewing zones for displaying the second image frame between a plurality of viewing zones provided during displaying of the first image frame.

3. The display apparatus of claim 2, wherein the controller is configured to drive the visual field separator to provide a first optical view of the first image frame and a second optical view of the first image frame adjacent to the first optical view to a first viewing zone and a second viewing zone adjacent to the first viewing zone, respectively, and to provide a third optical view of the second image frame to a third viewing zone between the first viewing zone and the second viewing zone.

4. The display apparatus of claim 3, wherein a distance between the first viewing zone and the third viewing zone corresponds to an average distance between right and left eyes of users, and
wherein the third optical view is a view from a viewpoint adjacent to a viewpoint for the first optical view.

5. The display apparatus of claim 3, wherein the visual field separator comprises a lens module comprising a plurality of electrodes and a liquid crystal layer configured to form lenses at different positions according to a position of an electrode with a voltage applied thereto among the plurality of electrodes, and
wherein the controller is configured to control to apply a voltage to a first electrode among the plurality of electrodes so as to form a lens corresponding to a region in which the first image frame is to be displayed, and to apply a voltage to a second electrode adjacent to the first electrode so as to form a lens at a position shifted by a preset interval for displaying the second image frame.

6. The display apparatus of claim 3, wherein the visual field separator comprises a barrier comprising a plurality of electrodes and configured to transmit or shield light emitted from the image panel according to whether a voltage is applied to the plurality of electrodes, and
wherein the controller is configured to control to apply a voltage to an electrode among the plurality of electrodes corresponding to a number of pixels of the image panel for displaying the first image frame, and to apply a voltage to another electrode among the plurality of electrodes for displaying the second image frame.

7. The display apparatus of claim 1, wherein a distance between the visual field separator and the image panel is equal to or less than 5 mm.

8. The display apparatus of claim 1, wherein the controller is configured to provide the first image frame and the second image frame at 120 Hz.

9. A display panel comprising:
an image panel comprising a plurality of pixels and configured to sequentially display a first image frame, comprising first multi-view images, and a second image frame comprising second multi-view images different from the first multi-view images, during one image frame period; and
a visual field separator disposed on a front surface of the image panel and configured to provide different optical views to respective viewing zones,
wherein the visual field separator configured to separate a visual field so as to shift a viewing zone provided for displaying the second image frame based on a viewing zone provided for displaying the first image frame.

10. The display panel of claim 9, wherein the visual field separator configured to separate the visual field so as to provide a first optical view and a second optical view adjacent to the first optical view to a first viewing zone and a second viewing zone adjacent to the first viewing zone, respectively, during displaying the first image frame, and to provide a third optical view to a third viewing zone between the first viewing zone and the second viewing zone during displaying the second image frame.

11. The display panel of claim 10, wherein the third optical view is a view from a viewpoint which is closest to a viewpoint for the first optical view among all optical views provided during displaying the second image frame.

12. A method of displaying a stereoscopic image at a display apparatus comprising an image panel comprising a plurality of pixels and configured to display an image frame in which multi-view images are disposed according to a preset arrangement pattern, and a visual field separator disposed on a front surface of the image panel and configured to provide different optical views to a plurality of viewing zones, the method comprising:
controlling the visual field separator to provide different optical views to respective preset viewing zones during displaying a first image frame, and to provide other different optical views to viewing zones respectively shifted from the preset viewing zones during displaying the second image frame.

13. The method of claim 12, wherein the controlling the visual field separator comprises differently controlling a driving state of the visual field separator to provide a plurality of viewing zones for displaying the other different optical views between the preset viewing zones for the displaying the first image frame.

14. The method of claim 13, wherein the controlling the visual field separator comprises driving the visual field separator to provide a first optical view of the first image frame and a second optical view of the first image frame adjacent to the first optical view to a first viewing zone and a second viewing zone adjacent to the first viewing zone, respectively, and to provide a third optical view of the second image frame to a third viewing zone between the first viewing zone and the second viewing zone.

15. The method of claim 14, wherein a distance between the first viewing zone and the third viewing zone corresponds to an average distance between right and left eyes of users, and
wherein the third optical view is a view from a viewpoint adjacent to a viewpoint for the first optical view.

16. The method of claim 14, wherein the third optical view is a view from a viewpoint which is closest to a viewpoint for the first optical view among all optical views provided during displaying the second image frame.

17. The method of claim 14, wherein the visual field separator comprises a lens module comprising a plurality of electrodes and a liquid crystal layer configured to form lenses at different positions according to a position of an electrode with a voltage applied thereto among the plurality of electrodes, and
wherein the controlling the visual field separator comprises controlling to apply a voltage to a first electrode among the plurality of electrodes so as to form a lens corresponding to a region in which the first image frame is to be displayed, and to apply a voltage to a second electrode adjacent to the first electrode so as to form a lens at a position shifted by a preset interval for displaying the second image frame.

18. The method of claim 14, wherein the visual field separator comprises a barrier comprising a plurality of electrodes and configured to transmit or shield light emitted from the image panel according to whether a voltage is applied to the plurality of electrodes, and
wherein the controlling the visual field separator comprises controlling to apply a voltage to an electrode among the plurality of electrodes corresponding to a number of pixels of the image panel for displaying the first image frame, and to apply a voltage to another electrode among the plurality of electrodes for displaying the second image frame.

19. The method of claim 12, wherein
a distance between the visual field separator and the image panel is equal to or less than 5 mm.

20. The method of claim 12, wherein the first image frame and the second image frame are provided at 120 Hz.
